(19) United States
(12) Patent Application Publication
(10) Pub. No.: US 2013/0112661 A1
(43) Pub. Date: May 9, 2013

(54) RAPID CHANGE MIG NOZZLE CONFIGURATIONS AND RELATED METHODS

(71) Applicant: Robert A. DAMBRA, Sharon Center, OH (US)

(72) Inventor: Robert A. DAMBRA, Sharon Center, OH (US)

(21) Appl. No.: 13/661,872

(22) Filed: Oct. 26, 2012

Related U.S. Application Data
(60) Provisional application No. 61/551,669, filed on Oct. 26, 2011.

(51) Int. Cl. B23K 9/16

(52) U.S. Cl. CPC B23K 9/16
USPC 219/74

(57) ABSTRACT

A rapid change nozzle apparatus includes a nozzle member and a seat or base member wherein the nozzle member may be quickly and easily manually selectively connected with and/or detached from the seat or base member in order for maintenance personnel or operators of an associated welding system to conveniently replace the nozzle as necessary or desired without significant down-time impact relative to the underlying welding processes. The nozzle member is supported relative to the base or seat member by a set of pin members extending from the base member and received in longitudinal and circumferential grooved in the nozzle member body, and by the biasing influence of a spring member disposed between the nozzle member and the base member whereby the spring urges the nozzle member into relative separation from the base member and into contact with the locating pin members.

### CROSS REFERENCE TO RELATED APPLICATIONS

This application claims priority to U.S. Provisional Application No. 61/551,669, filed on Oct. 26, 2011, the entire contents of which are incorporated herein by reference.

### BACKGROUND

There is a need in the welding industry for faster preventative maintenance down-time stops during production hours. More particularly, there is a need to reduce the time required to perform preventative maintenance such as, for example, replacement of consumable welding tips which typically wear out or otherwise degrade during normal use thereof.

Metal inert gas (MIG) welding involves the sealing and joining of non-ferrous metals such as for example aluminum. Inherent in all MIG Metal Inert Gas automation and robotic processes is the desire of maximizing utilization of the investment producing product(s) so that a reasonable return on investment may be attained. In the case of production robotic MIG welding, the investment is the purchase of automated equipment or robots. During the MIG welding process, consumables must be replaced and/or cleaned periodically during operating hours. During these times, the robot or equipment remains idle waiting for the items to be removed manually by operators. Reducing this time is critical in running an efficient production facility.

### BRIEF SUMMARY OF EXAMPLE EMBODIMENT

A rapid change nozzle apparatus is provided including a nozzle member and a seat or base member wherein the nozzle member may be quickly and easily manually connected with and/or detached from the seat or base member in order for maintenance personnel or operators of an associated welding system to conveniently replace the nozzle as necessary or desired without significant down-time impact relative to the underlying welding processes.

In an example embodiment, the nozzle member is supported relative to the base or seat member by a set of pin members extending from the base member and by the biasing influence of a spring member disposed between the nozzle member and the base member whereby the spring urges the nozzle member into relative separation from the base member and into contact with the locating pin members.

In the example embodiment, the nozzle member includes a set of elongate grooves configured to receive the locating pins. A longitudinally extending portion of the grooves is provided for helping to co-locate the central longitudinal axes of the nozzle and base members and to help guide the nozzle member onto the base member. A circumferentially extending portion of the grooves is provided for helping to locate the members in an attached relative position following initial relative rotation of the members whereby the pin members become seated in shoulder regions provided in the grooves whereat the pins may contact the nozzle member after the rotation thereby holding the nozzle member in the grooves and in place relative to the base member. The circumferential groove may be a spiral groove in an alternative embodiment. In another embodiment, both the longitudinally extending portion as well as the circumferentially extending portion of the set of elongate grooves provided on the nozzle member can be replaced with a single groove having a general spiral conformation. In any case, the spiral nature or shoulder region of the circumferential groove assists in selectively coupling the nozzle tip member body with the base or seat member body and in resisting decoupling by inadvertent associated forces.

The subject rapid change nozzle apparatus addresses nozzle change-out time as well as product longevity. It is typical for an operator to take up to 40 seconds to remove and replace a standard threaded nozzle. During 3 separate tests, this time may be reduced using the subject apparatus of the example embodiment to an average of 6 seconds. Additionally, where thread forms wear out on typically threaded designed products, the rapid change nozzle apparatus allows for all friction points and retaining force to be directed in a static axial relationship against a harder fixed material. The simple act of removing and installing the items has little to no wear on the product. The life of the rapid change nozzle apparatus due to normal use is expected at 4-6 times that of a standard nozzle.

For purposes of summarizing the disclosure, certain aspects, advantages and novel features of the example embodiment have been described herein. It is to be understood that not necessarily all such advantages may be achieved in accordance with any particular embodiment of the claimed invention. Thus, the claimed invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The example embodiment of the invention is further described in the detailed description which follows, in reference to the noted drawings by way of non-limiting examples of the example embodiment of the present invention, in which like reference numerals represent similar parts throughout the several views of the drawings, and wherein:

FIG. 1 is a perspective view of a rapid change nozzle apparatus for use with an associated welding system in accordance with an example embodiment;

FIG. 2 is a perspective view of a base member portion of the a rapid change nozzle apparatus of FIG. 1 in accordance with the example embodiment and with the set of locating pins members removed ease of understanding and illustration;

FIG. 3 is a top elevational view of the base member portion of the example embodiment shown in FIG. 2;

FIG. 4 is a side elevational view of the base member portion of the example embodiment shown in FIG. 2;

FIG. 5 is a cross-sectional view of the base member portion of the example embodiment shown in FIG. 2 and taken along line 5-5 of FIG. 4;

FIG. 6 is an enlarged view of the portion of the base member portion of the example embodiment within the circle marked 6 in FIG. 3;

FIG. 7 is a top elevational view of a tip member portion of the a rapid change nozzle apparatus of FIG. 1 in accordance with the example embodiment;

FIG. 8 is a side elevational view of a tip member portion of the a rapid change nozzle apparatus of FIG. 1 in accordance with the example embodiment;

FIG. 9 is a cross-sectional view of the tip member portion of the example embodiment shown in FIGS. 1, 7, and 8 and taken along line 9-9 of FIG. 7;

FIG. 10 is a cross-sectional view of the tip member portion of the example embodiment shown in FIGS. 1, 7, and 8 and taken along line 10-10 of FIG. 8;

FIG. 11 is a perspective view of a locating pin member of the rapid change nozzle apparatus in accordance with the example embodiment;

FIG. 12a shows a side elevational view of the subject rapid change nozzle apparatus in accordance with the example embodiment in an initial pre-aligned stage of mutual interconnection;

FIG. 12b shows a side elevational view of the subject rapid change nozzle apparatus in accordance with the example embodiment in an initial aligned stage of mutual interconnection;

FIG. 12c shows a side elevational view of the subject rapid change nozzle apparatus in accordance with the example embodiment in an aligned pre-latched stage of mutual interconnection and at a position between longitudinal and circumferential groove portions; and,

FIG. 12d shows a side elevational view of the subject rapid change nozzle apparatus in accordance with the example embodiment in a completed latched stage of mutual interconnection wherein the nozzle apparatus is ready for use with the associated welding system.

### DETAILED DESCRIPTION

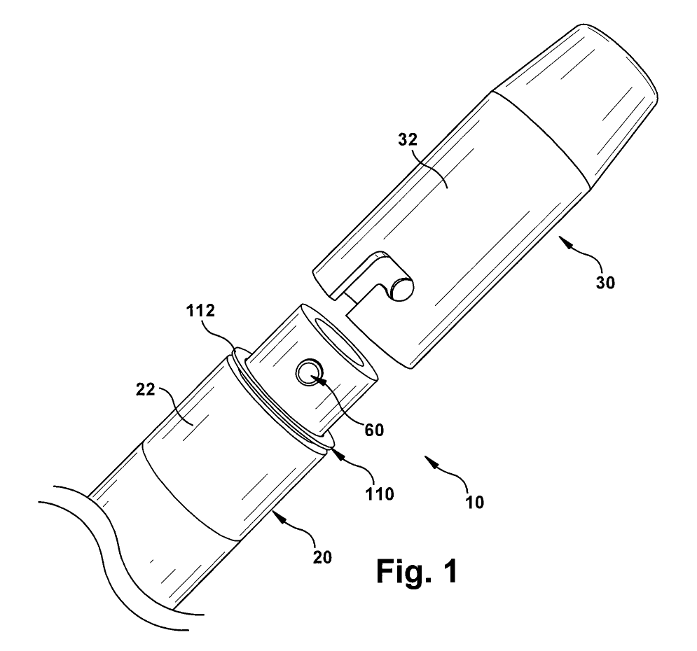

With reference now to the drawing Figures wherein purposed are for illustrating the example embodiment only and no for purposes of limiting the invention, FIG. 1 is a perspective view of a rapid change nozzle apparatus 10 in accordance with an example embodiment for use with an associated welding system A shown schematically in the drawing. The rapid change nozzle apparatus 10 of the example embodiment includes, in general, a base member 20 comprising a base member body 22 and a tip member 30 comprising a tip member body 32. In accordance with the example embodiment, the base member body 22 is configured to selectively receive with the tip member body 32 along mutually coextensive central longitudinal axes and couple with the tip member body 32 in relative opposite rotational directions about mutually coextensive central longitudinal axes in a manner to be described in greater detail below. Advantageously, in accordance with the example embodiment, the tip member body 32 is easily removable from the base member body 22 by hand making its replacement, such as in a welding applications and in other work environments, quick and easy.

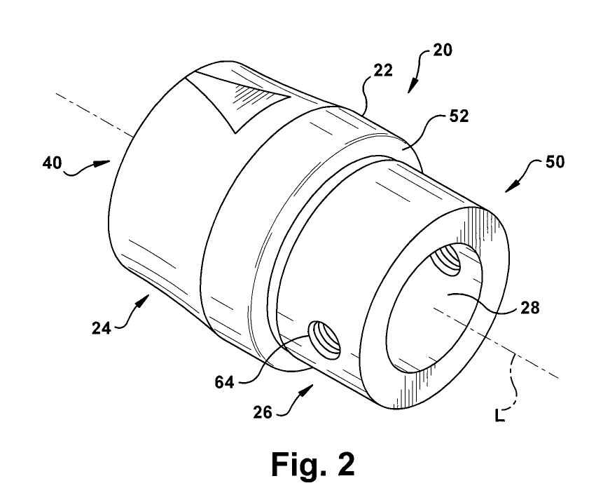

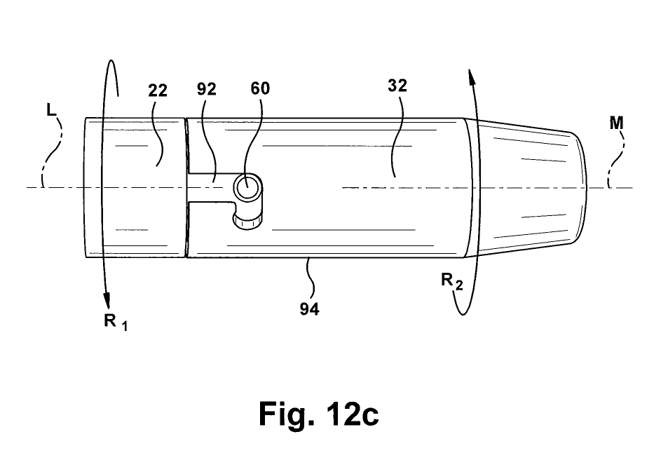

FIG. 2 is a perspective view of a base member portion 20 of the rapid change nozzle apparatus of FIG. 1 in accordance with the example embodiment and with the set of locating pin members 60 (FIG. 11) removed for ease of understanding and illustration of the base member portion. The base member 20 comprises a base member body 22 having on opposite first 24 and second 26 ends and defining a first hollow passageway 28 extending therethrough. The first end 24 of the base member body 22 comprises a connection portion 40 being configured for selective connecting of the base member 20 with the associated welding system A. The second end 26 of the base member body 22 comprises a coupling portion 50 forming a substantially planar front face surface 52, wherein the first hollow passageway 28 opens in the planar front face surface 52 and is configured for communicating an associated fluid (not shown) from the associated welding system A (FIG. 1) between the first 24 and second 26 ends and through the hollow passageway 28 of the base member body 22.

FIGS. 1 and 11 illustrate a set of locating pin members 60 carried on the base member body 22 in accordance with the example embodiment. For reasons to be described below, preferably, the set of locating pin members 60 are disposed in a fixed position relative to the base member 20 and extend radially relative to a longitudinal axis L extending in a direction perpendicular to the planar front face surface 52 of the base member body 22.

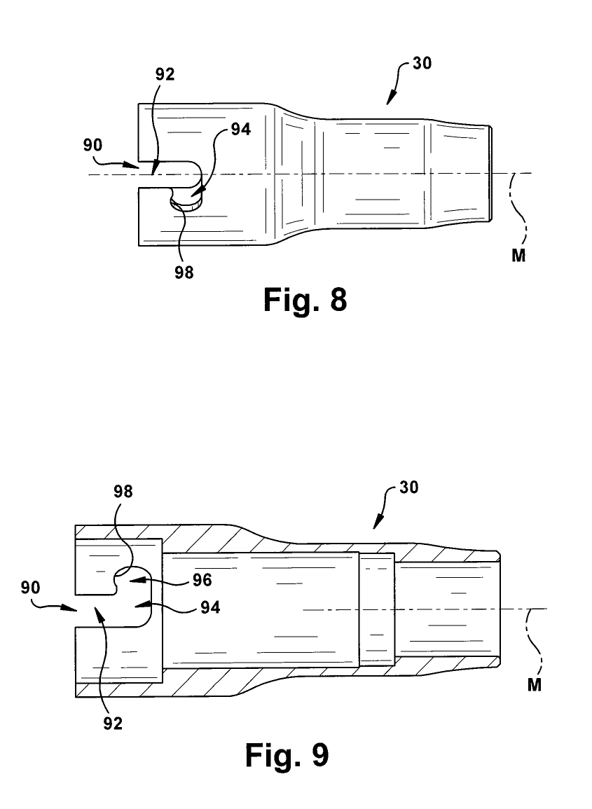

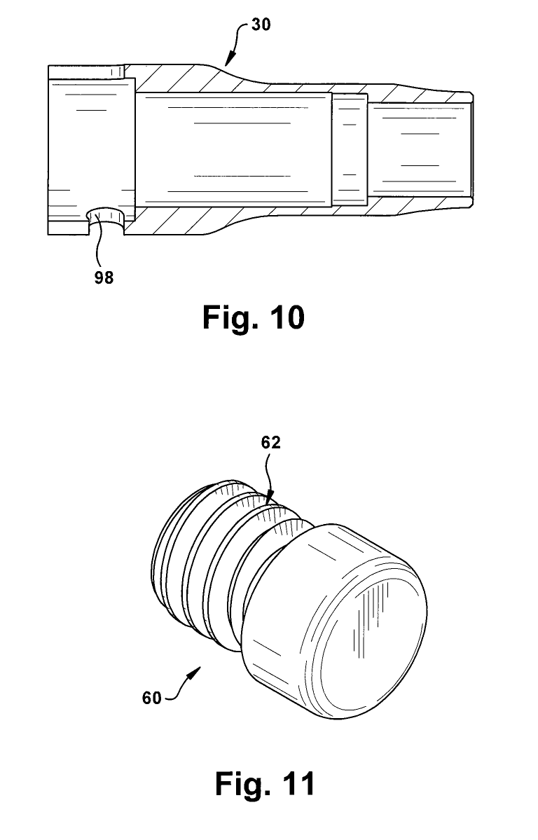

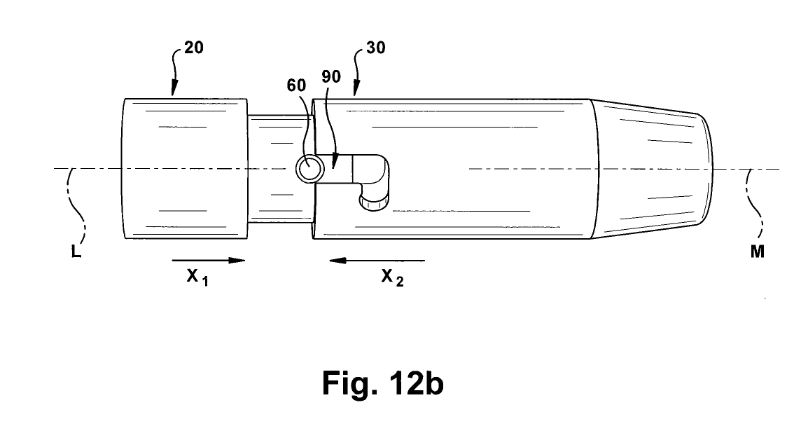

With reference next to FIGS. 1 and 7-10, the tip member 30 comprises a tip member body 32 having opposite first 34 and second 36 ends and defining a second hollow passageway 38 extending therethrough. The first end 34 of the tip member body 32 comprises an attachment portion 70 being configured for selective attaching of the tip member 30 with the coupling portion 50 of the base member body 22 for receiving the associated fluid from the first hollow passageway 28 into the second hollow passageway 38. The second end 36 of the tip member body 32 comprises a nozzle portion 80 configured to direct the associated fluid towards an associated workpiece (not shown) adjacent the nozzle portion 80 during use of the subject rapid change nozzle apparatus 10. In its preferred form, the attachment portion 70 defines a set of locating openings 90 corresponding to the set of locating pin members 60 wherein the set of locating openings 90 are configured to selectively receive the set of locating pin members 60 therein such as by threaded engagement or the like whereby the attached pins provide for rapidly and easily manually coupling and decoupling the tip member 30 relative to the base member 20. Further, as shown, the attachment portion 70 defines a substantially planar annular coupling surface 100 on the first end 34 of the tip member body 32.

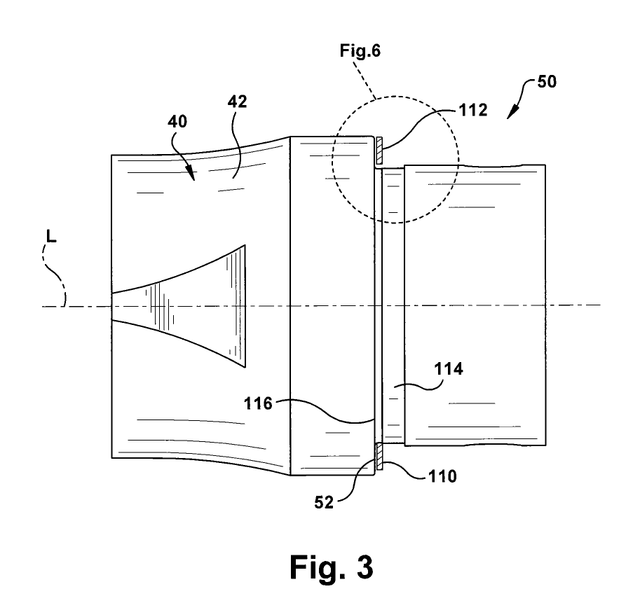

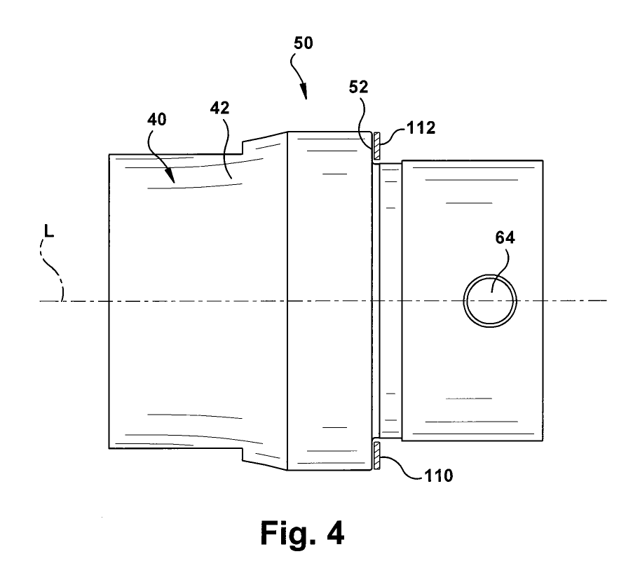

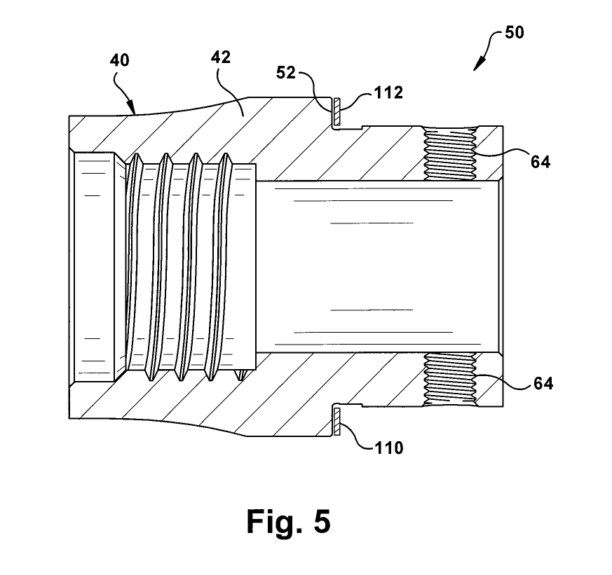

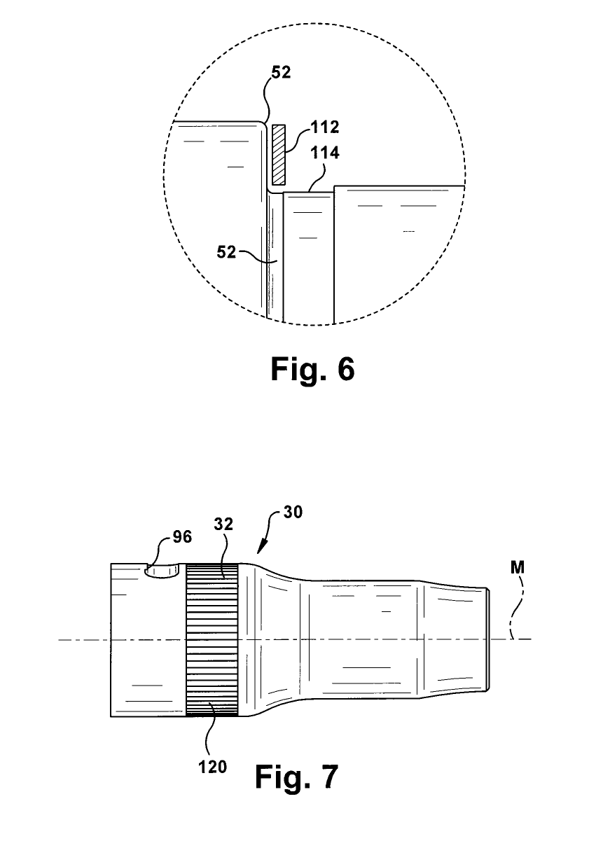

As best shown in FIGS. 2-6, the subject rapid change nozzle apparatus 10 further includes a biasing member 110 disposed between the base and tip members 20, 30. Functionally, the biasing member 110 is configured to contact and urge the base and tip member bodies 22, 32 into relative separation whereby the tip member 30 is held relative to the base member 20 substantially exclusively by contact of the biasing member 110 with the planar front face surface 52 of the base member body 22 and the planar annular coupling surface 100 of the tip member body 32, together with contact of the set of locating pin members 60 with the set of locating openings 90. Preferably, the biasing member 110 is a spring washer 112 retained in a groove 114 defined on the base member body 22 and having suitable properties for accomplishing the function identified above and in accordance with the desired welding application.

In accordance with one example embodiment, the base member 20 is in the form of a nozzle seat manufactured from 360 brass. However, in practice, any material can be used as long as it resists temperatures up to 700 degrees F., which is typical in a front-end welding environment. Furthermore, the material preferably has good machining characteristics so that the retaining pins can be easily installed. It is also helpful that the material forming the base member 20 in the form of a nozzle seat be an efficient thermal conductor, but this characteristic not necessary in all applications. Other materials which can be used include bronze, tool steels, stainless steels, aluminum and certain classes of copper. It is important, however, that the machining tolerances are maintained or otherwise followed on the outer diameter of the nozzle seat where the nozzle installs so that shielding in MIG welding application of the example embodiment gas does not escape between the base and tip portions. Studies show a tolerance of 0.002-0.004 below nozzle inner diameter is highly desirable. In addition, tightening this fit may reduce or eliminate aspirating atmosphere into the gas blanket within the nozzle through a Venturi effect.

With continued reference to the drawing Figures, a groove 114 cut at the base of the nozzle seat to allow a free float for the spring washer 112. The spring washer will be sized such that it is a press fit onto the seat until it reaches this groove, then it will more freely. This fit will also restrict the spring washer from falling back down onto the retaining pins when removing the nozzle in the vertical down position. The back side of the nozzle seat can be machined to fit onto various MIG gun configurations. Different thread forms can be identified and machined into the unit to allow for seamless installations. Further machining of components provides the undercut 116 where the groove 114 meets the base or face 52 of the nozzle seat. This allows the retaining spring to sit flush against the wall which will provide a uniform force against the nozzle while held by the retaining pins.

It is to be appreciated that, preferably, the spring type washer 112 is installed over the outer diameter of the nozzle seat prior to installing retaining pins. This is a press fit over the outer diameter of the nozzle seat, but will free float when reaching a machined groove on the back shoulder of the nozzle seat. The nozzle seat is machined such that the spring sits flush against the larger diameter of the nozzle seat. This advantageously provides a uniform force onto the nozzle when restricted by the retaining pins. This force is uniformly spread against the entire base of the nozzle and is axially directed into the nozzle which in turn transmits the force onto a set of static harder pins 60. Different configurations of spring washers have been used depending on the desired force to restrict movement of the nozzle. Materials range from hardened steels, stainless steels and brass. Additionally the thickness of the unit combined with the material is dictated by the desired force. Thickness ranges have been from 0.009″-0.025″.

It is to be further appreciated that, preferably, the set of locating pins 60 are affixed onto the nozzle seat after the wave washer 112 has been installed. In the example embodiment, the pins are provided with male threads 62 which thread into mating holes 64 strategically located into the seat. However, the pins may also be soldered, brazed or glued in place if a more permanent assembly is desired. The outer free ends of the pins 60 are configured to slide into the vertical nozzle grooves on the nozzle for alignment. Additionally, they bear the entire axial force of the wave washer, tension against the wave washer. When the washer 112 is compressed and the pins have cleared the centerline of the horizontal nozzle groove, the nozzle is selectively manually rotated clockwise approximately 23 degrees until the pins seat themselves into retaining slots machines into the nozzle. The pins bear the entire stress of the wave washer while stabilizing the nozzle from additional stresses during the welding process. A relevant aspect is that the material has a harder tensile strength than the nozzle material being utilized. In this way, any wear from installing and removing the nozzle if not done correctly will only wear the nozzle itself, which is treated within the industry as a consumable. Further benefits of the treaded installation of the pins allow for replacement of the pins themselves in the event of a failure due to robotic crash or similar, saving the cost of an entire unit. In addition, this modular set-up also allows for replacement or change of the wave washer in the event it fails or the customer desires a different set-up. The pins are also machined so that after installation they are only slightly larger across their outer diameter than the nozzle outer diameter. In addition, the outside edge may be smooth and the corners broken so that no sharp edges remain that would hinder manual install of the nozzle, especially where the operator has heavy welding gloves.

In practice, the nozzle 22 can be machined from various material suitable for MIG welding nozzles. The material should handle temperatures up to 700 degrees F. without any sufficient breakdown. Some suitable materials are 260 and 360 brass. C145 copper, steels and some metalized carbons. Additionally, the features and benefits of each material should be weighed as to which would benefit the process itself. This design does not affect material choice as it pertains to how the nozzle performs during the welding process itself. It is also beneficial that the material be an adequate thermal conductor. Furthermore, the nozzle can be machined with or without a permanent insulator affixed to the inner diameter. For shielding gas flow, the through hole or I.D. bore size should be straight if possible. A taper is acceptable for any inner diameter under 9/16″. The finish of all surfaces machines with a maximum 32 micro to aid in gas delivery and resist spatter adhesion and cleaning.

In embodiments, the inner diameter of the nozzle in the region where it slides over the nozzle seat preferably does not exceed 0.007″ over the nominal outer diameter of the nozzle seat to restrain nozzle from lateral movement in the event of spring wear and to negate any gas leakage between the mating surfaces.

In embodiments, when assembled, the distance between the back of the nozzle (closest to the nozzle seat) and the nozzle seat edge where the spring rests is preferably not more than the spring diameter plus 0.020″-0.025″. This allows for good compression of the spring creating an axial stabilizing force sufficient enough to resist an unsuspected impact as well as creating a thermal pathway for heat to work its way back toward the outer tube of the assembly where the ambient air can better cool the unit.

In embodiments, the groove paths preferably does not exceed 0.010″-0.020″ over the nominal pin diameter to allow for clearance but restrict any “play” within the assembly during installation.

In embodiments, the horizontal groove may be located so that there is a minimum of 0.015″-0.020″ overlap of material between the nozzle and nozzle seat, again restricting gas leakage through the horizontal grooves.

Other features of the example embodiment include an outer diameter knurling region 120 to aid in installation while wearing heavy welding gloves.

As shown in the drawings such as in FIG. 2 the base member body 22 is substantially cylindrical and defines a base member body longitudinal axis L. As noted above, preferably, the planar front face surface 52 of the base member body 22 is substantially perpendicular to the a longitudinal axis L. Also as noted an above, the set of locating pin members 60 not shown in FIG. 2 for clarity and ease of discussion, are disposed in a fixed position relative to the base member 20 and extend radially outwardly to the longitudinal axis L. In the example embodiment, the set of locating pin members 60 form an angle of about 0° relative to the longitudinal axis L.

It is to be appreciated that although the set of locating pin members 60 in the example embodiment extend radially outwardly to the longitudinal axis L and that a portion of the tip member body 32 surrounds a portion of the base member body 22, other embodiments may equivalently include the set of locating pin members 60 in the example embodiment extend radially inwardly from the base member body 22 and towards the longitudinal axis L and that a portion of the base member body 22 surrounds a portion of the tip member body 22.

In addition to the above, in the example embodiment, the set of locating pins 60 are carried on the base member body and are spaced apart circumferentially equidistant on the base member body. In the example embodiment, a set of two (2) locating pins are used and they are circumferentially spaced apart by 180°. However, three (3) locating pins may be used and they may be circumferentially spaced apart by 120°. Four (4) locating pins would be circumferentially spaced apart by 90°, etc.

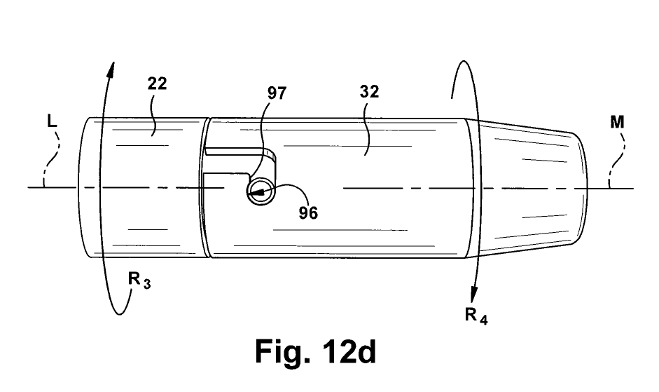

In the example rapid change nozzle apparatus 10, the tip member body 32 is substantially cylindrical and defines a tip member body longitudinal axis M. It is to be appreciated that in the assembled or coupled orientation of the tip member 30 relative to the base member 20 such as shown in FIG. 12c, the tip member body longitudinal axis M is co-extensive with the base member body longitudinal axis L.

To ensure interoperability, the set of locating openings 90 matches in number the set of locating pins 60. Accordingly, the set of locating openings 90 defined by the attachment portion 70 of the tip member body 32 are spaced apart circumferentially equidistant on the tip member body 32. In the example embodiment, a set of two (2) locating openings are used and they are circumferentially spaced apart by 180°. However, three (3) locating openings may be used and they may be circumferentially spaced apart by 120°. Four (4) locating openings would be circumferentially spaced apart by 90°, etc.

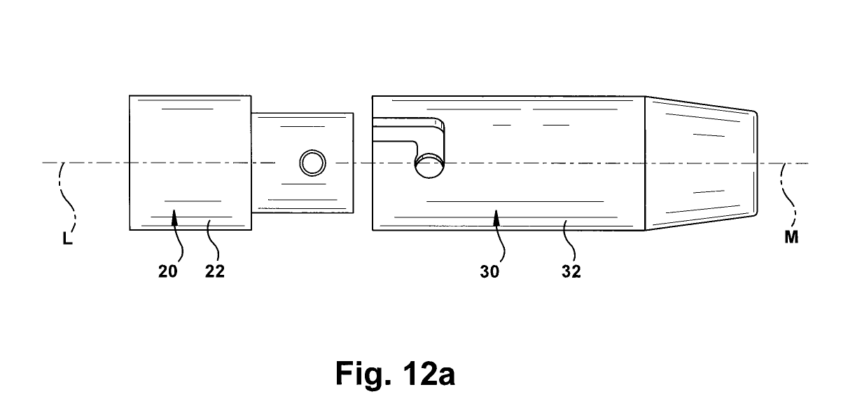

As shown best in FIG. 9, each locating opening of the set of locating openings comprises a longitudinal alignment slot portion 92 extending in a direction substantially parallel to the tip member body longitudinal axis M, and a circumferential locking slot portion 94 contiguous with the longitudinal alignment slot portion 92. However, the circumferential locking slot portion 94 extends circumferentially along the tip member body around the tip member body longitudinal axis M. In this way, following rotation of the tip member body relative to the base member body, the locking pins become received in the circumferential locking slot portion 94 causing mutual coupling of the tip with the base.

In accordance with the construction of the example embodiment as set out above, each alignment slot portion 92 is configured to slidably receive a corresponding a corresponding locking pin member 60 to constrain relative movement between the tip and base members to relative linear movement substantially parallel to the tip and base member body longitudinal axes M, L while the tip and base member are brought into initial mutual alignment whereat the tip and base member body longitudinal axes are coextensive. In addition, each locking slot portion 94 is configured to slidably receive a corresponding locking pin member 60 to constrain relative movement between the tip and base members to relative rotational movement substantially about the tip and base member body longitudinal axes while the tip and base member are brought into mutual relative connection.

In the example embodiment as shown best in FIG. 9, each locking slot portion 94 defines a recess shoulder region 96 having a recess shoulder surface 98 extending on the nozzle member body in a direction parallel to the tip member body longitudinal axis M and configured to slidably engage a corresponding locking pin member 60. In this way, the biasing member 110 urges each locking pin member 60 against a corresponding recess shoulder surface 98 thereby selectively coupling the tip member body 32 with the base member body 22 and resisting decoupling by inadvertent associated forces.

As noted and given the construction described immediately above, the pin members 60 bear the entire axial force of the wave washer 112 and thereby provide an opposing or tension against the wave washer compressing it biased between the planar front face surface 52 and the planar annular coupling surface 100 on the first end 34 of the tip member body 32. When the washer is compressed and the pins have cleared the centerline of the horizontal nozzle groove, the nozzle is rotated clockwise approximately 23 degrees until the pins seat themselves into retaining slots machines into the nozzle. The pins bear the entire stress of the wave washer while stabilizing the nozzle from additional stresses during the welding process. A relevant aspect is that the material has a harder tensile strength than the nozzle material being utilized. In this way, any wear from installing and removing the nozzle if not done correctly will only wear the nozzle itself, which is treated within the industry as a consumable.

FIGS. 12a-12c illustrate stages of relative mutual connection between the b, and 12c the tip and body members 20, 30. FIG. 12a shows a side elevational view of the subject rapid change nozzle apparatus in accordance with the example embodiment in an initial pre-aligned stage of mutual interconnection. With the tip member body 22 spaced from the base member body 32, the bodies are initially aligned so that the longitudinal axis M of the tip member body 32 becomes co-extensive with the longitudinal axis L of the base member body 22.

FIG. 12b shows a side elevational view of the subject rapid change nozzle apparatus in accordance with the example embodiment in an initial aligned stage of mutual interconnection. More particularly, with the tip member body longitudinal axis M co-extensive with the base member body longitudinal axis L and while maintaining that relationship, the nozzle body 32 is manually rotated about its axis M so that the longitudinal alignment slot portion 92 of the longitudinal alignment slots are aligned with the set of pin members 60 as shown in the Figure. After establishing the desired alignment, the base body member 22 may be moved linearly in a direction x₁ and/or the tip member body may be moved linearly in a direction x₂. This would place the members in the relative position shown in FIG. 12c described below.

FIG. 12c shows a side elevational view of the subject rapid change nozzle apparatus in accordance with the example embodiment in an aligned pre-latched stage of mutual interconnection and wherein the set of positioning pins 60 are located at a position between longitudinal 92 and circumferential 94 groove portions. Compression of the biasing member (not shown in the Figure for clarity) is at its maximum extent with the base and tip member bodies in the position illustrated in the Figure. After establishing the desired pre-latched stage alignment illustrated, the base body member 22 may be rotated about its longitudinal axis L a direction R₁ and/or the tip member body may be rotated about its longitudinal axis M a direction R2. This would place the members in the relative position shown in FIG. 12d described below.

FIG. 12d shows a side elevational view of the subject rapid change nozzle apparatus in accordance with the example embodiment in a completed latched stage of mutual interconnection wherein the nozzle apparatus is ready for use with the associated welding system. In this position, each of the locking pin members 60 are received in the As described above, each locking slot portion 94 is configured to slidably receive a corresponding locking pin member 60 to constrain relative movement between the tip and base members to relative rotational movement substantially about the tip and base member body longitudinal axes while the tip and base member held in their mutual relative connection. Mutual relative alignment is assisted by the slidable engagement between the inner surface of the tip portion as it is received on the outer surface of the base member in the region of mutual overlap of the member bodies 22, 32. In the example embodiment and as shown, each locking slot portion 94 defines a recess shoulder region 96 having a recess shoulder surface 98 extending on the nozzle member body in a direction parallel to the tip member body longitudinal axis M and configured to slidably engage a corresponding locking pin member 60. In this way, the biasing member 110 urges each locking pin member 60 against a corresponding recess shoulder surface 98 thereby selectively coupling the tip member body 32 with the base member body 22 and resisting decoupling by inadvertent associated forces. After establishing the desired completed latched stage of mutual interconnection illustrated, the base body member 22 may be rotated about its longitudinal axis L a direction R₃ and/or the tip member body may be rotated about its longitudinal axis M a direction R₄. This would place the members in the relative position shown in FIG. 12c described below. However, prior to this relative rotational movement, the spring member is slightly compressed between the body members 22, 32 owing to the lip surface 97 at the outer extent of the passageway 94. As can be seen in the Figure, the lip surface 97 is spaced a greater distance from the end surface of the attachment portion 70 than the recess shoulder region 96, thereby requiring overcoming the spring force before relative rotation. This is beneficial because, in this way, the biasing member 110 urges each locking pin member 60 against a corresponding pocket region defined by the corresponding recess shoulder surface 98 thereby resisting decoupling by inadvertent associated forces.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A rapid change nozzle apparatus for use with an associated welding system, the rapid change nozzle apparatus comprising:
a base member comprising a base member body having on opposite first and second ends and defining a first hollow passageway extending therethrough, the first end of the base member body comprising a connection portion being configured for selective connecting of the base member with the associated welding system and the second end of the base member body comprising a coupling portion forming a substantially planar front face surface, wherein the first hollow passageway opens in the planar front face surface and is configured for communicating an associated fluid from the associated welding system between the first and second ends of the base member body;
a set of locating pin members disposed in a fixed position relative to the base member and extending radially relative to a longitudinal axis extending in a direction perpendicular to the planar front face surface of the base member body;
a tip member comprising a tip member body having opposite first and second ends and defining a second hollow passageway extending therethrough, the first end of the tip member body comprising an attachment portion being configured for selective attaching of the tip member with the coupling portion of the base member body for receiving the associated fluid into the second hollow passageway and the second end of the tip member body comprising a nozzle portion configured to direct the associated fluid towards an associated workpiece, the attachment portion defining a set of locating openings corresponding to the set of locating pin members wherein the set of locating openings are configured to selectively receive the set of locating pin members therein and the attachment portion defining a substantially planar annular coupling surface on the first end of the tip member body; and,
a biasing member disposed between the base and tip members and being configured to contact and urge the base member and tip member bodies into relative separation whereby the tip member is held relative to the base member substantially exclusively by: i) contact of the biasing member with the planar front face surface of the base member and the planar annular coupling surface of the tip member, and ii) contact of the set of locating pin members with the set of locating openings.

2. The rapid change nozzle apparatus according to claim 1 wherein:
the base member body is substantially cylindrical defining a base member body longitudinal axis; and,
the set of locating pins are carried on the base member body and extend radially relative to the base member body longitudinal axis.

3. The rapid change nozzle apparatus according to claim 2 wherein the set of locating pins are spaced apart circumferentially equidistant on the base member body.

4. The rapid change nozzle apparatus according to claim 3 wherein:
the tip member body is substantially cylindrical defining a tip member body longitudinal axis;
the set of locating openings matches in number the set of locating pins; and,
the set of locating openings defined by the attachment portion of the tip member body are spaced apart circumferentially equidistant on the tip member body.

5. The rapid change nozzle apparatus according to claim 4 wherein:
each locating opening of the set of locating openings comprises a longitudinal alignment slot portion extending in a direction substantially parallel to the tip member body longitudinal axis, and a circumferential locking slot portion contiguous with the longitudinal alignment slot portion, the circumferential locking slot portion extending circumferentially along the tip member body around the tip member body longitudinal axis.

6. The rapid change nozzle apparatus according to claim 5 wherein:
each alignment slot portion is configured to slidably receive a corresponding a corresponding locking pin member to constrain relative movement between the tip and base members to relative linear movement substantially parallel to the tip and base member body longitudinal axes while the tip and base member are brought into initial mutual alignment whereat the tip and base member body longitudinal axes are coextensive; and,
each locking slot portion is configured to slidably receive a corresponding locking pin member to constrain relative movement between the tip and base members to relative rotational movement substantially about the tip and base member body longitudinal axes while the tip and base member are brought into mutual relative connection.

7. The rapid change nozzle apparatus according to claim 6 wherein:
each locking slot portion defines a recess shoulder region having a recess shoulder surface extending on the nozzle member body in a direction parallel to the base member body longitudinal axis and configured to slidably engage a corresponding locking pin member, wherein the biasing member urges each locking pin member against a corresponding recess shoulder surface thereby selectively coupling the tip member body with the base member body and resisting decoupling by inadvertent associated forces.

8. The rapid change nozzle apparatus according to claim 5 wherein:
each alignment slot portion is configured to slidably receive a corresponding a corresponding locking pin member to constrain relative movement between the tip and base members to relative linear movement substantially parallel to the tip and base member body longitudinal axes while the tip and base member are brought into initial mutual alignment whereat the tip and base member body longitudinal axes are coextensive; and,
each locking slot portion defines a receding shoulder region having a receding shoulder surface extending on the nozzle member body in a direction parallel to the base member body longitudinal axis and configured to slidably engage a corresponding locking pin member, wherein the biasing member urges each locking pin member against a corresponding receding shoulder surface thereby selectively coupling the tip member body with the base member body and resisting decoupling by inadvertent associated forces.

9. The rapid change nozzle apparatus according to claim 2 wherein:
the set of locating pin members extending radially outwardly relative to the base member body longitudinal axis and define a relative angle of inclination relative to the base member body longitudinal axis of about 0°.
